(19) United States
(12) Patent Application Publication
(10) Pub. No.: US 2026/0197483 A1
(43) Pub. Date: Jul. 9, 2026

(54) VIDEO CODING METHOD AND DEVICE USING MIXED CROSS-COMPONENT PREDICTION

(71) Applicants: HYUNDAI MOTOR COMPANY, SEOUL (KR); KIA CORPORATION, SEOUL (KR); DIGITALINSIGHTS INC., SEOUL (KR)

(72) Inventors: Yong Jo Ahn, Seoul (KR); Jong Seok Lee, Seoul (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); DIGITALINSIGHTS INC., SEOUL (KR)

(21) Appl. No.: 18/865,895

(22) PCT Filed: Apr. 21, 2023
(86) PCT No.: PCT/KR2023/005498

§ 371 Date: Nov. 14, 2024

(30) Foreign Application Priority Data
May 16, 2022 (KR) 10-2022-0059415
Apr. 19, 2023 (KR) 10-2023-0051389

(51) Int. Cl. H04N 19/50; H04N 19/176

(52) U.S. Cl. CPC H04N 19/50; H04N 19/176

(57) ABSTRACT

A method and an apparatus are disclosed for video coding using mixed cross-component prediction. In the disclosed embodiments, a video decoding device generates a linear model (LM) prediction block of a current chroma block by performing cross-component prediction according to an LM mode, and generates a non-LM prediction block of the current chroma block by performing prediction according to a non-LM mode. The video decoding device generates a final chroma prediction block of the current chroma block by combining the LM prediction block and the non-LM prediction block based on weights.

### TECHNICAL FIELD

The present disclosure relates to a method and an apparatus using mixed cross-component prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Meanwhile, cross-component prediction technology mainly predicts chroma components based on the similarity between a luma component and a chroma component constituting a block. Existing video compression standards have difficulty adopting cross-component prediction due to the occurrence of cross-component dependency according to cross-component prediction. However, VVC, the latest standard, applies cross-component prediction technology based on a linear model to predict chroma components. For example, a technology is applied to predict a chroma component block from a luma component block for cross-component prediction. In the future, in order to improve video encoding efficiency and video quality, it is necessary to consider improving cross-component prediction technology in predicting chroma components.

### DISCLOSURE

### Technical Problem

The present disclosure seeks to provide a video coding method and an apparatus that, in predicting a chroma component of a current block, generate a prediction block using the existing intra prediction and generate a prediction block using a cross-component linear model. The video coding method and the apparatus combine the prediction blocks based on a weighted sum of block units to generate a final prediction block.

In addition, the present disclosure seeks to provide a video coding method and an apparatus that, in predicting a chroma component of a current block, generate a final prediction block by blending prediction blocks based on geometric division.

### Technical Solution

At least one aspect of the present disclosure provides a method of mixed cross-component prediction, performed by a video decoding device. The method also includes generating a linear model (LM) prediction block of a current chroma block by performing cross-component prediction according to an LM mode. The LM mode uses a cross-component linear model. The method also includes generating a non-LM prediction block of the current chroma block by performing prediction according to a non-LM mode. The non-LM mode uses a directionality-based intra prediction mode. The method also includes generating a final chroma prediction block of the current chroma block by combining the LM prediction block and the non-LM prediction block based on weights.

Another aspect of the present disclosure provides a method of mixed cross-component prediction of a current chroma block, performed by a video encoding device. The method includes generating a linear model (LM) prediction block of the current chroma block by performing cross-component prediction according to an LM mode. The LM mode uses a cross-component linear model. The method also includes generating a non-LM prediction block of the current chroma block by performing prediction according to a non-LM mode. The non-LM mode uses a directionality-based intra prediction mode. The method also includes generating a first final chroma prediction block of the current chroma block by combining the LM prediction block and the non-LM prediction block based on weights for each block. The method also includes generating a second final chroma prediction block of the current chroma block by combining the LM prediction block and the non-LM prediction block based on weights for each pixel position.

Yet another aspect of the present disclosure provides a computer-readable recording medium storing a bitstream generated by a video encoding method. The video encoding method includes generating a linear model (LM) prediction block of the current chroma block by performing cross-component prediction according to an LM mode. The LM mode uses a cross-component linear model. The video encoding method also includes generating a non-LM prediction block of the current chroma block by performing prediction according to a non-LM mode. The non-LM mode uses a directionality-based intra prediction mode. The video encoding method also includes generating a first final chroma prediction block of the current chroma block by combining the LM prediction block and the non-LM prediction block based on weights for each block. The video encoding method also includes generating a second final chroma prediction block of the current chroma block by combining the LM prediction block and the non-LM prediction block based on weights for each pixel position.

### Advantageous Effects

As described above, the present disclosure provides a video coding method and an apparatus that generate a prediction block using the existing intra prediction and generate a prediction block using a cross-component linear model. The video coding method and the apparatus combine the prediction blocks based on a weighted sum of block units to generate a final prediction block. Thus, the video coding method and the apparatus increase video coding efficiency and enhance video quality.

In addition, the present disclosure provides a video coding method and an apparatus that, in predicting a chroma component of a current block, generate a final prediction block by blending prediction blocks based on geometric division. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram conceptually illustrating a cross-component prediction technique.

FIG. 7 is a diagram illustrating pixels adjacent to a current luma block and a current chroma block.

FIG. 8 is a diagram illustrating cross-component prediction using one linear model or two linear models.

FIG. 9 is a block diagram illustrating an intra predictor according to an embodiment of the present disclosure.

FIG. 10 is a diagram conceptually illustrating mixed cross-component prediction according to an embodiment of the present disclosure.

FIG. 11 is a block diagram illustrating an intra predictor according to another embodiment of the present disclosure.

FIGS. 12A and 12B are diagrams conceptually illustrating geometric mixed cross-component prediction according to an embodiment of the present disclosure.

FIG. 13 is a block diagram illustrating an intra predictor according to another embodiment of the present disclosure.

FIG. 14 is a flowchart illustrating a mixed cross-component prediction method performed by a video encoding device according to an embodiment of the present disclosure.

FIG. 15 is a flowchart illustrating a mixed cross-component prediction method performed by a video decoding device according to an embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

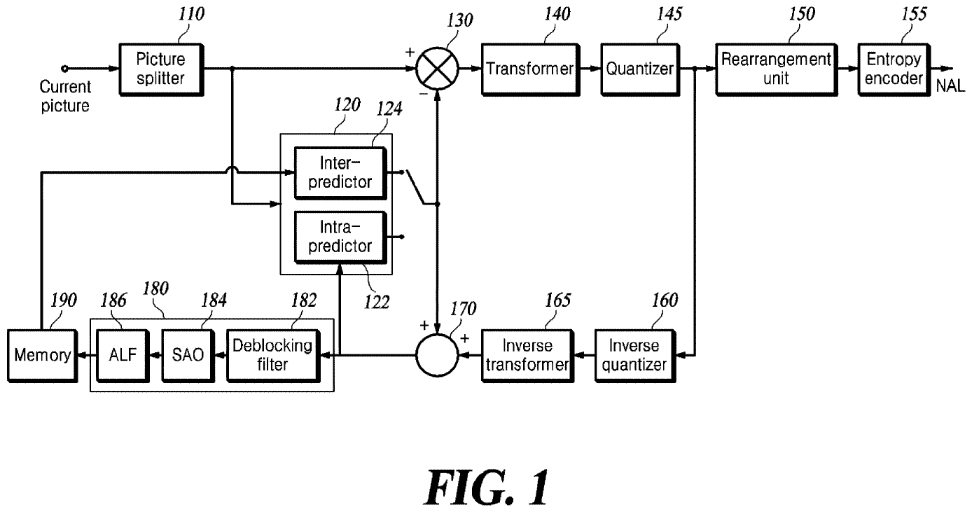

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

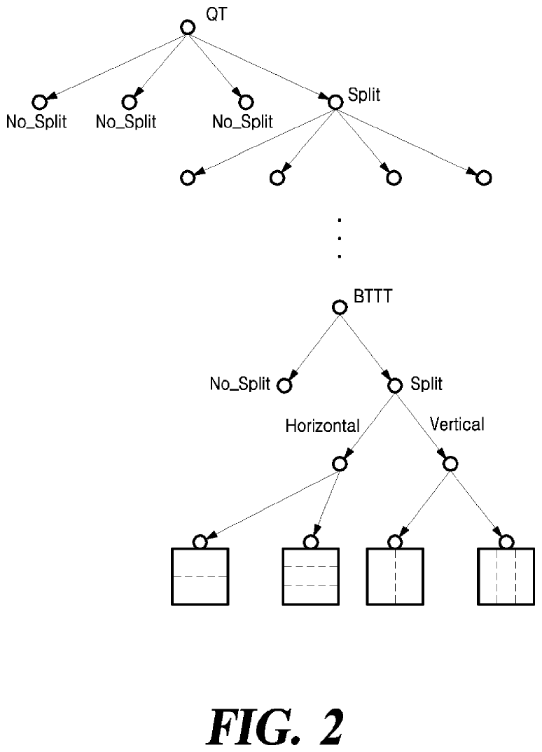

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

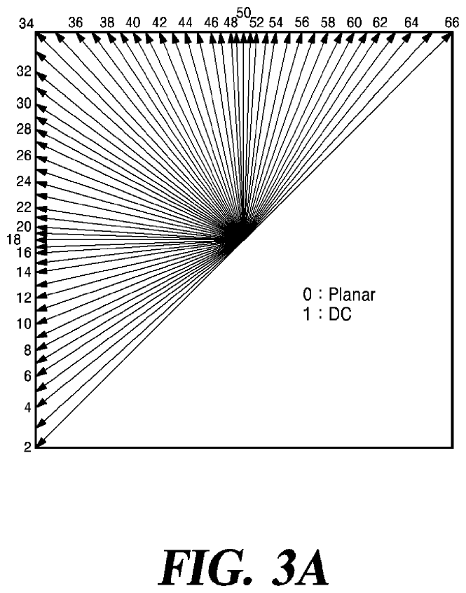

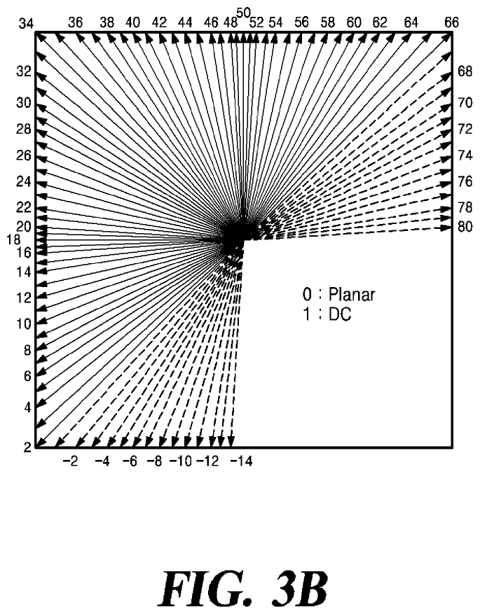

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

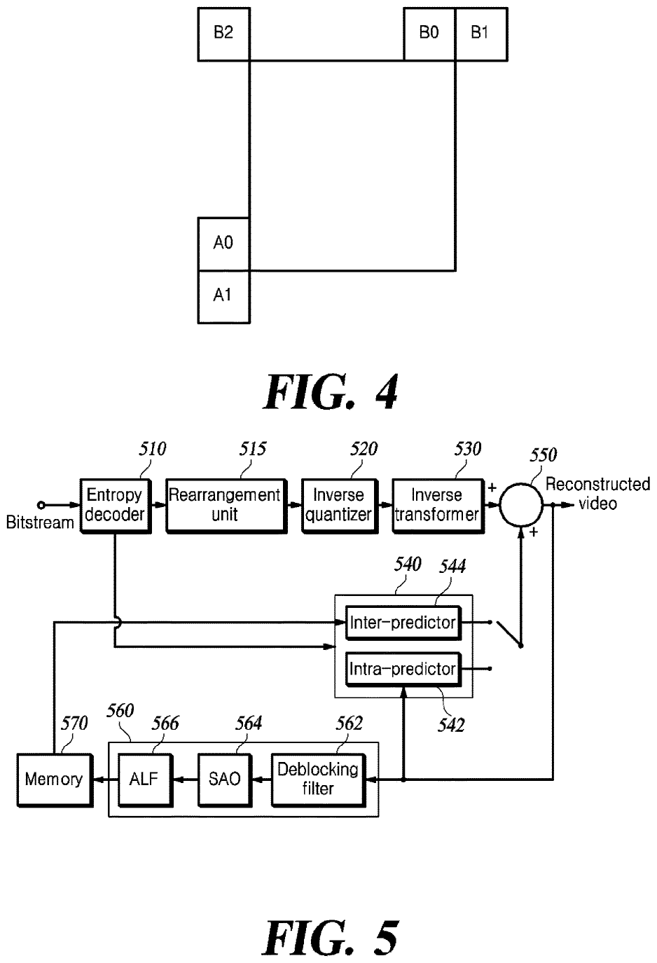

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that generate a prediction block using the existing intra prediction and generate a prediction block using a cross-component linear model. In predicting a chroma component of a current block, the video coding method and the apparatus blend the prediction blocks based on different weights of predefined pixel units to generate a final prediction block.

The following embodiments may be performed by the intra predictor 122 in the video encoding device. The following embodiments may also be performed by the intra predictor 542 in the video decoding device.

The video encoding device in the prediction of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the prediction of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

The following embodiments are described based on the intra predictor 542 in the video decoding device, but may be similarly applied to the intra predictor 122 of the video encoding device.

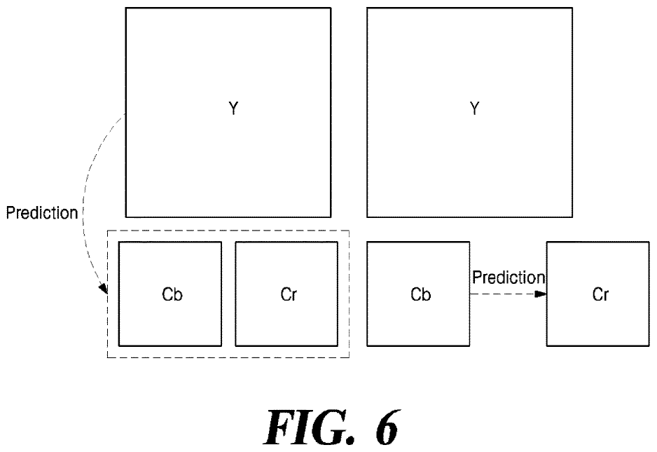

FIG. 6 is a diagram conceptually illustrating a cross-component prediction technique.

As in the example of FIG. 6, there may be one luma component and one or more corresponding chroma components constituting one block. Here, as illustrated in FIG. 6, the cross-component prediction technique predicts two chroma component blocks (hereinafter, ‘chroma blocks’) from one luma component block (hereinafter, ‘luma block’) or predicts the other chroma component block from one chroma component block with respect to two different chroma component blocks.

As an example, as in the left example of FIG. 6, when there is a luma block Y and two corresponding chroma blocks Cb and Cr, the video decoding device may derive pixel similarity between the luma block and the chroma blocks as one linear model. The video decoding device may generate a prediction block of the chroma block from the luma block using the derived linear model. Here, the linear model may be implemented as in Equation 1.

$$p r e {d}_{c} ( i , j ) = α \cdot {rec}_{y} ( i , j ) + β \qquad [ Equation 1 ]$$

Here, pred_{c}(i,j) represents a prediction pixel at a (i,j) position of the chroma block, and rec_{y}(i,j) represents a reconstructed pixel at a (i,j) position of the luma block. In addition, α and β represent parameters of a linear model based on the pixel similarity between the luma block and the chroma block. α and β may be signaled from the video encoding device to the video decoding device. Alternatively, the parameters may be derived based on the same arithmetic operation in the video encoding device and the video decoding device.

As another example, as in the right example of FIG. 6, chroma cross-component prediction may be performed. In other words, the video decoding device may predict the other chroma block from one chroma block with respect to two different chroma component blocks. For example, a prediction block of the Cr component may be corrected as in Equation 2 using a residual signal of the Cb component.

$$p r e {d}_{c r}^{′} ( i , j ) = p r e {d}_{c r} ( i , j ) + α \cdot {resi}_{c b} ( i , j ) \qquad [ Equation 2 ]$$

Here, pred′_{cr}(i,j) represents a prediction pixel at a position (i,j) of the prediction block of the corrected Cr component, and pred_{cr}(i,j) represents a prediction pixel at a position (i,j) of the prediction block of the Cr component before correction. resi_{cb}(i,j) represents a prediction pixel at a (i,j) position of the residual block of the Cb component. In addition, a represents a linear parameter of a linear model based on pixel similarity between the Cb component block and the Cr component block. α may be signaled from the video encoding device to the video decoding device. Alternatively, the corresponding parameter may be derived based on the same arithmetic operation in the video encoding device and the video decoding device.

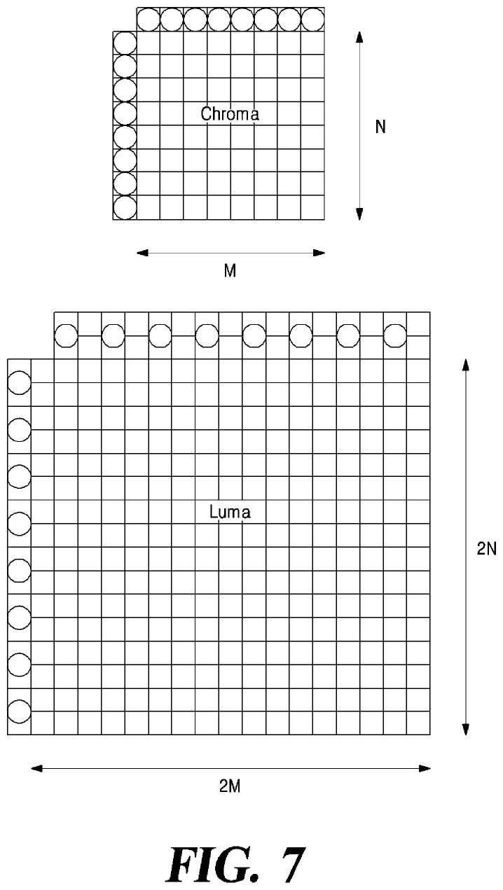

Meanwhile, in order to derive the parameters of the linear model described above, as in the example of FIG. 7, spatially adjacent pixels of the reconstructed luma block (or, corresponding luma block) and spatially adjacent pixels of the current chroma block may be used. The adjacent pixels illustrated in FIG. 7 represent a case in which a chroma format of the current picture is YUV 4:2:0. If a color format is YUV 4:4:4, YUV 4:2:2, or the like, positions of the adjacent pixels of the corresponding luma block may be changed.

In addition, in performing cross-component prediction, as in the example of FIG. 7, the reconstructed pixels spatially adjacent to the luma block and the chroma block may be pixels spatially adjacent to the top and left of the block.

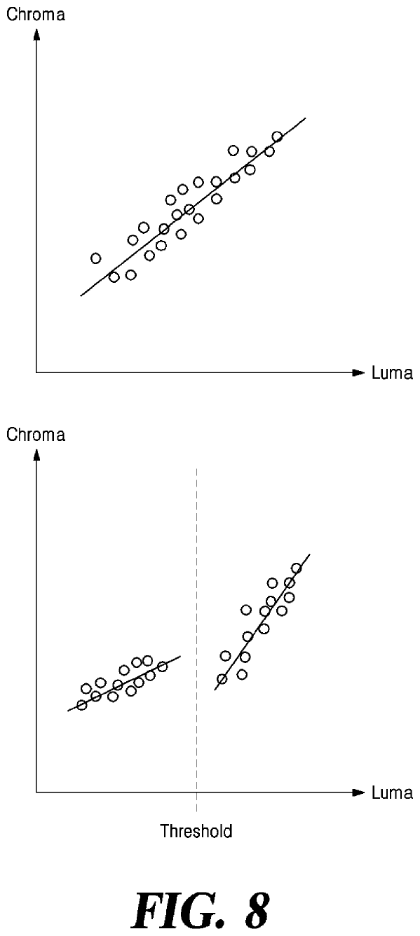

FIG. 8 is a diagram illustrating cross-component prediction using one linear model or two linear models.

As in the example of FIG. 8, the video decoding device may use one or more linear models to perform cross-component prediction. In the example of FIG. 8, each dot represents a pair of a chroma pixel and a corresponding luma pixel.

For example, the video decoding device may derive one linear model using a distribution of pixel values of the two components. In the left example of FIG. 8, one linear model is derived using the distribution of pixel values of the luma component and the chroma component. Thereafter, the video decoding device may perform cross-component prediction using the linear model derived for the chroma component.

Alternatively, if the distribution of pixel values between the two components is difficult to define with one linear model, the video decoding device may derive one or more linear models. In the right example of FIG. 8, two linear models are derived using the distribution of pixel values of the luma component and the chroma component depending on whether the luma pixel values are greater than a preset threshold. Thereafter, the video decoding device may perform cross-component prediction using the two linear models derived for the chroma component.

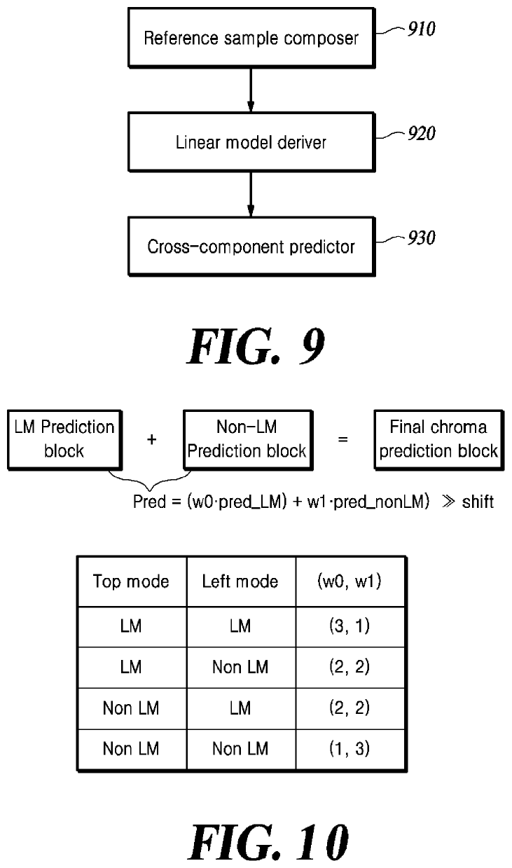

FIG. 9 is a block diagram illustrating an intra predictor according to an embodiment of the present disclosure.

The intra predictor 542 of the video decoding device illustrated in FIG. 5 may include components, such as the example of FIG. 9, in order to perform cross-component prediction. The intra predictor 542 may include all or some of a reference sample composer 910, a linear model deriver 920, and a cross-component predictor 930. Meanwhile, the intra predictor 122 of the video encoding device illustrated in FIG. 1 may also include such components as those of the example of FIG. 9 in order to perform cross-component prediction.

As described above, the intra predictor 542 may derive a linear model used for cross-component prediction using samples spatially adjacent to a current block and a reference component block (hereinafter, ‘reference block’) and then may generate a prediction block of the current block by applying the linear model to the reconstructed reference block. Here, if the reference block is a reconstructed luma block, the current block is a current chroma block. Or, if the reference block is a reconstructed Cb block, the current block may be a Cr block.

The reference sample composer 910 sets positions of reference samples spatially adjacent to the current block and the reference component block in order to derive parameters of the linear model. In addition, the reference sample composer 400 may pad reference sample values in positions at which pixel values are not available.

The linear model deriver 920 derives parameters of a linear model for cross-component prediction. Here, the linear model deriver 920 may derive parameters of the linear model based on the similarity between adjacent pixels of the reference block and the current block. The linear model based on the derived parameters is transferred to the cross-component predictor 930.

The cross-component predictor 930 generates a prediction pixel of the current pixel by applying the linear model to the pixels in the reconstructed reference block corresponding to the pixels in the current block. Here, the number and corresponding positions of the pixels in the reconstructed reference block corresponding to the current pixel may be changed. Accordingly, the number and corresponding positions of the corresponding pixels may be configured as a plurality of combinations.

FIG. 10 is a diagram conceptually illustrating a mixed cross-component prediction according to an embodiment of the present disclosure.

As shown in the example of FIG. 10, the mixed (or fusion) cross-component prediction technique according to the present disclosure combines a prediction block (hereinafter, ‘LM prediction block’) acquired using a cross-component prediction mode (hereinafter, ‘LM mode’) based on a linear model and a prediction block (hereinafter, ‘non-LM prediction block’) acquired using an existing intra prediction mode to generate a final chroma prediction block of the current chroma block. Here, the existing intra prediction mode represents a prediction mode that performs directional prediction based on spatial pixel similarity. Hereinafter, the mixed cross-component prediction technique as shown in the example of FIG. 10 is used interchangeably with the ‘mixed LM mode’.

As shown in the example of FIG. 10, in combining an LM prediction block and a non-LM prediction block, the intra predictor 542 may use a weighted sum. The intra predictor 542 may adaptively select a weight w0 for the LM prediction block and a weight w1 for the non-LM prediction block according to a specific condition in the weighted sum operation. Here, the specific condition may be a prediction mode of a block adjacent to the current block. First, if prediction modes of blocks located on top and to the left of the current block are all LM modes, the weight w0 for the LM prediction block may be a greater value than the weight w1 for the non-LM prediction block. In other words, as in the example of FIG. 10, w0 may be 3 and w1 may be 1.

Or, if the prediction modes of the blocks located on top and to the left of the current block are different, the weight w0 for the LM prediction block and the weight w1 for the non-LM prediction block may be the same value. In other words, as in the example of FIG. 10, w0 may be 2 and w1 may be 2.

Alternatively, if the prediction modes of the blocks located on top and to the left of the current block are not all LM modes, the weight w0 for the LM prediction block may be a smaller value than the weight w1 for the non-LM prediction block. In other words, as in the example of FIG. 10, w0 may be 1 and w1 may be 3.

Meanwhile, by setting a shift value for the weighted sum to 2, w0+w1=1 may be satisfied.

The intra predictor 542 performs mixed cross-component prediction as follows.

First, the intra predictor 542 determines whether to use the cross-component prediction mode (i.e., LM mode) based on a linear model or the existing intra prediction mode for the current chroma block. To this end, information indicating whether to use the LM mode for the current chroma block may be signaled. Here, the corresponding information may be a single flag applied indiscriminately to two chroma component blocks Cb and Cr. Alternatively, the corresponding information may be two different flags for the two chroma component blocks. Hereinafter, the information indicating whether to use the LM mode is referred to as ‘LM mode information’.

If the LM mode information does not indicate the use of the LM mode, the intra predictor 542 generates a prediction block of the current chroma block according to the existing intra prediction mode.

Meanwhile, if the LM mode information indicates the use of the LM mode, the intra predictor 542 determines whether to use the mixed LM mode or the general LM mode. To this end, information indicating whether to use the mixed LM mode for the current chroma block may be signaled. Here, the corresponding information may be one flag applied indiscriminately to the two chroma component blocks Cb and Cr at once. Alternatively, the corresponding information may be two different flags for the two chroma component blocks. Hereinafter, the information indicating whether to use the mixed LM mode is referred to as ‘mixed LM mode information’.

If the mixed LM mode information does not indicate the use of the mixed LM mode, the intra predictor 542 generates a prediction block of the current chroma block by performing cross-component prediction based on a linear model according to the general LM mode. Here, the intra predictor 542 may perform prediction according to the general LM mode using the components illustrated in FIG. 9.

If the mixed LM mode information indicates the use of the mixed LM mode, the intra predictor 542 generate a final chroma prediction block of the current chroma block by performing mixed cross-component prediction as illustrated in FIG. 10.

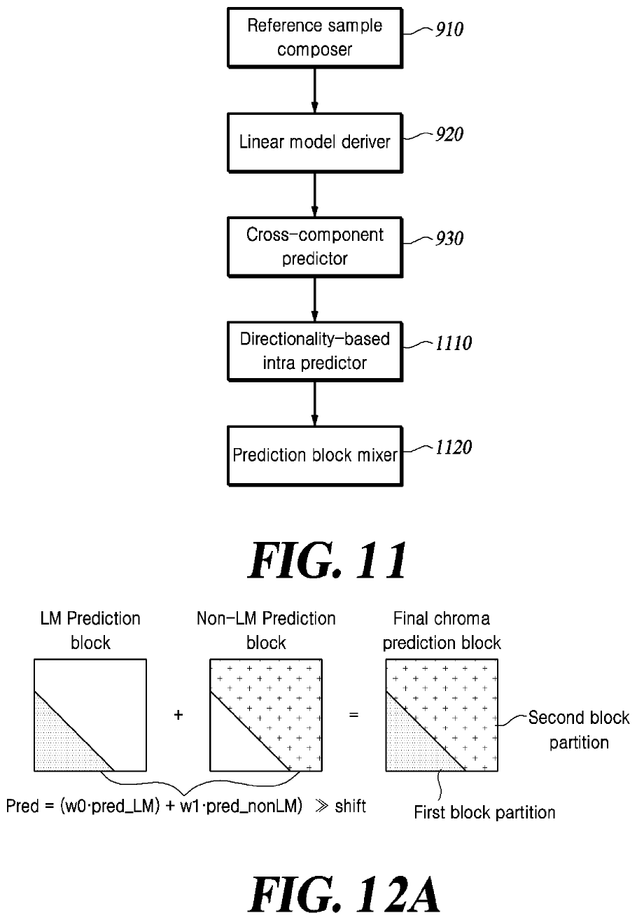

Hereinafter, components within the intra predictor 542 that perform the mixed LM mode as described above are described using the diagram of FIG. 11.

FIG. 11 is a block diagram illustrating an intra predictor according to another embodiment of the present disclosure.

In order to perform mixed cross-component prediction, the intra predictor 542 may further include a directionality-based intra predictor 1110 and a prediction block mixer 1120 in addition to the components illustrated in FIG. 11. Meanwhile, the intra predictor 122 of the video encoding device may also include components, such as those of the example of FIG. 11, in order to perform mixed cross-component prediction.

Since the operations of the reference sample composer 910, the linear model deriver 920, and the cross-component predictor 930 have already been described, further description is omitted.

The directionality-based intra predictor 1110 performs directionality prediction based on pixels spatially adjacent to a current chroma block according to the existing intra prediction mode to generate a non-LM prediction block. However, in the mixed cross-component prediction technology according to the present disclosure, intra prediction may be performed using one of the limited intra prediction modes instead of using all existing directionality.

The prediction block mixer 1120 combines the LM prediction block and the non-LM prediction block of the current chroma block to generate a final chroma prediction block. Here, as in the example of FIG. 10, the prediction block mixer 1120 may combine the LM prediction block and the non-LM prediction block of the current chroma block using a weighted sum.

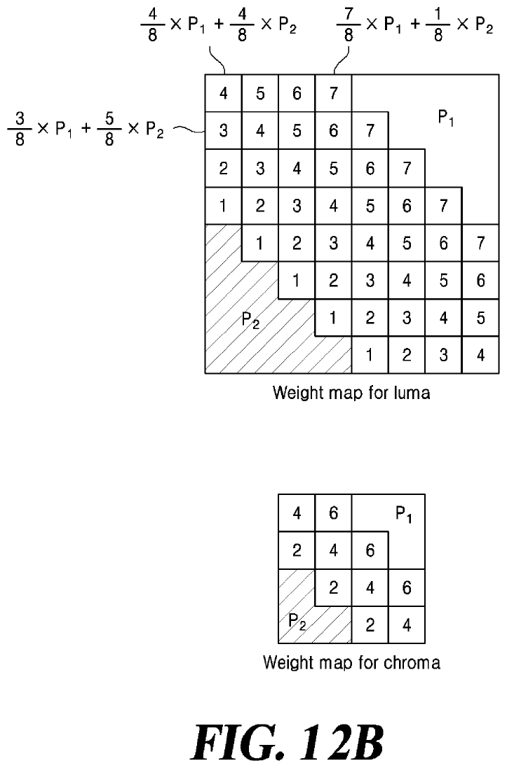

FIG. 12A and FIG. 12B are diagrams conceptually illustrating geometric mixed cross-component prediction according to an embodiment of the present disclosure.

As in the examples of FIG. 12A and FIG. 12B, the geometric mixed cross-component prediction technology according to the present disclosure generates a final chroma prediction block of the current chroma block by combining a prediction block (i.e., an LM prediction block) acquired using a cross-component prediction mode (i.e., the LM mode) based on a linear model and a prediction block (i.e., a non-LM prediction block) acquired using an existing intra prediction mode. As in the examples of FIGS. 12A and 12B, when combining the LM prediction block and the non-LM prediction block, the intra predictor 542 may generate a final chroma prediction block by applying a weight according to a pixel position that imitates geometric block partitioning.

Meanwhile, geometric block partitioning divides a block into a first block partition and a second block partition, as in the example of FIG. 12A.

In order to combine the LM prediction block and the non-LM prediction block, the intra predictor 542 may use a weighted sum based on a geometric partition mode (GPM). In the weighted sum operation, the intra predictor 542 may set different values for each pixel position according to a geometric partition form of the current chroma block with a weight w0 for the LM prediction block and a weight w1 for the non-LM prediction block.

For example, as in the example of FIG. 12B, different weights may be set for each pixel based on a distance from a straight line (hereinafter, ‘bisecting straight line’) that divides the current chroma block into two. In the example of FIG. 12B, P1 may be the non-LM prediction block, and P2 may be the LM prediction block. In addition, the weights w0 and w1 of the current chroma block may be one of {0, 2, 4, 6, 8}. Here, by setting a shift value for the weighted sum to 3, w0+w1=1 may be satisfied.

As described above, when the GPM-based weighted sum is used, the intra predictor 542 performs geometric mixed cross-component prediction as follows.

First, the intra predictor 542 determines whether to use the linear model-based cross-component prediction mode (i.e., the LM mode) or the existing intra prediction mode for the current chroma block. To this end, LM mode information indicating whether to use the LM mode for the current chroma block may be signaled. In this case, the LM mode information may be one flag applied indiscriminately to the two chroma component blocks Cb and Cr. Alternatively, the LM mode information may be two different flags for the two chroma component blocks.

If the LM mode information does not indicate the use of the LM mode, the intra predictor 542 generates a prediction block of the current chroma block according to the existing intra prediction mode.

Meanwhile, if the LM mode information indicates the use of the LM mode, the intra predictor 542 determines whether to use the mixed LM mode or the general LM mode. To this end, mixed LM mode information indicating whether to use the mixed LM mode for the current chroma block may be signaled. Here, the mixed LM mode information may be one flag applied indiscriminately to two chroma component blocks Cb and Cr. Alternatively, the mixed LM mode information may be two different flags for the two chroma component blocks.

If the mixed LM mode information does not indicate the use of the mixed LM mode, the intra predictor 542 performs cross-component prediction based on a linear model according to the general LM mode to generate a prediction block of the current chroma block. Here, the intra predictor 542 may perform prediction according to the general LM mode using the components illustrated in FIG. 9.

If the mixed LM mode information indicates the use of the mixed LM mode, the intra predictor 542 determines whether to use the mixed LM mode or the geometric mixed LM mode. To this end, information indicating whether to use the geometric mixed LM mode for the current chroma block may be signaled. Here, the information may be one flag applied indiscriminately to two chroma component blocks Cb and Cr. Alternatively, the corresponding information may be two different flags for the two chroma component blocks. Hereinafter, the information indicating whether to use the geometric mixed LM mode is referred to as ‘geometric mixed LM mode information’.

If the geometric mixed LM mode information does not indicate the use of the geometric mixed LM mode, the intra predictor 542 generates a final prediction block of the current chroma block according to the mixed LM mode. Here, the intra predictor 542 may perform prediction according to the mixed LM mode using the components illustrated in FIG. 11.

If the geometric mixed LM mode information indicates the use of the geometric mixed LM mode, the intra predictor 542 performs geometric mixed cross-component prediction as illustrated in FIG. 12A and FIG. 12B to generate a final chroma prediction block of the current chroma block.

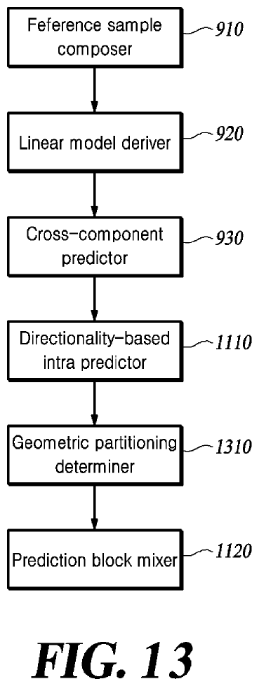

Hereinafter, components in the intra predictor 542 that perform the geometric mixed LM mode as described above are described using the diagram of FIG. 13.

FIG. 13 is a block diagram illustrating an intra predictor according to another embodiment of the present disclosure.

In order to perform geometric mixed cross-component prediction, a geometric partitioning determiner 1310 may be further included in addition to the components illustrated in FIG. 11. Meanwhile, the intra predictor 122 of the video encoding device may also include components, such as those of the example of FIG. 13 in order to perform mixed cross-component prediction.

Hereinafter, the operations of the reference sample composer 910, the linear model deriver 920, the cross-component predictor 930, and the directionality-based intra predictor 1110 are the same as those of the example of FIG. 11, so further description is omitted.

The geometric partitioning determiner 1310 determines a form of the geometric block partitioning of the current chroma block. The geometric partitioning determiner 1310 parses an index indicating a form of geometric block partitioning of the current chroma block. In addition, the geometric partitioning determiner 1310 parses information indicating whether a prediction mode of the first block partition and the second block partition of the current chroma block is the LM mode or the non-LM mode, i.e., prediction mode information for each block partition.

The prediction block mixer 1120 combines the LM prediction block and the non-LM prediction block of the current chroma block to generate a final chroma prediction block. Here, as in the example of FIG. 12B, the prediction block mixer 1120 combines the LM prediction block and the non-LM prediction block using the index indicating the form of the geometric block partitioning and the prediction mode information for each block partition. In other words, the prediction block mixer 1120 may generate the final chroma prediction block by performing a blending process that simulates the geometric block partitioning.

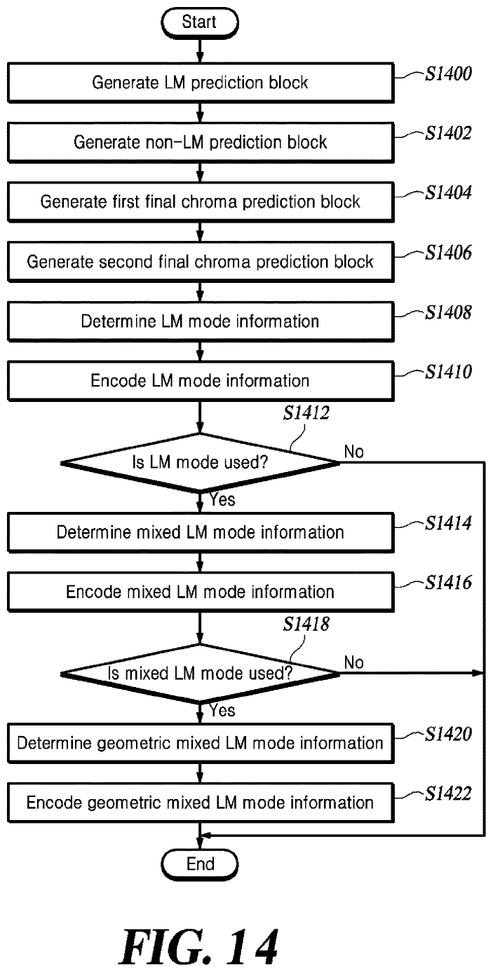

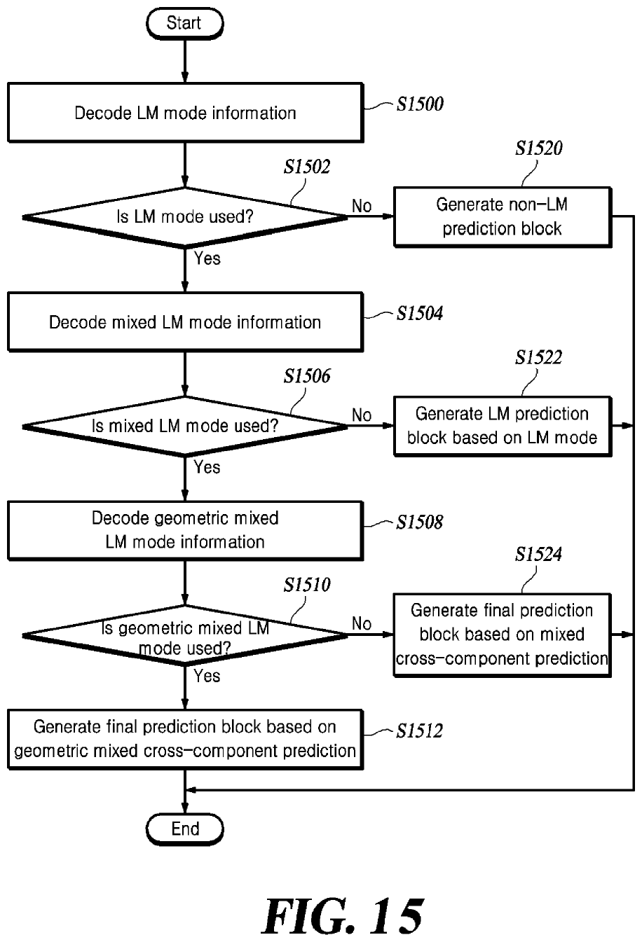

Hereinafter, a mixed cross-component prediction method of a current chroma block is described using the illustrations of FIGS. 14 and 15.

FIG. 14 is a flowchart illustrating a mixed cross-component prediction method of a current chroma block performed by a video encoding device according to an embodiment of the present disclosure.

The video encoding device performs cross-component prediction according to the LM mode to generate an LM prediction block of the current chroma block (S1400). Here, the LM mode predicts the current chroma block using a cross-component linear model.

First, the video encoding device sets positions of reference samples adjacent to the current chroma block and the reference block. The video encoding device derives a linear model based on the similarity between the adjacent reference samples of the current chroma block and the reference block. Thereafter, the video encoding device may generate an LM prediction block by applying the linear model to pixels in the reference block corresponding to pixels in the current chroma block.

The video encoding device performs prediction according to the non-LM mode to generate a non-LM prediction block of the current chroma block (S1402). Here, the non-LM mode predicts the current chroma block using a directionality-based intra prediction mode.

The video encoding device generates a first final chroma prediction block of the current chroma block by combining the LM prediction block and the non-LM prediction block based on weights for each block (S1404).

For example, the video encoding device may set weights for each block based on the prediction mode of blocks located on top and to the left of the current chroma block. The video encoding device may combine the LM prediction block and the non-LM prediction block based on weights for each block.

The video encoding device generates a second final chroma prediction block of the current chroma block by combining the LM prediction block and the non-LM prediction block based on the weights for each pixel position (S1406).

First, the video encoding device determines an index indicating a form of the geometric block partitioning of the current chroma block and determines prediction mode information for each block partition of the current chroma block. Here, the prediction mode information for each block partition indicates the prediction mode of the first block partition and the second block partition of the current chroma block according to the index. The video encoding device may determine the form of the geometric block partitioning and the prediction mode information for each block partition in terms of rate distortion optimization. The video encoding device may combine the LM prediction block and the non-LM prediction block based on the set weights for each pixel position.

The video encoding device determines LM mode information based on the LM prediction block, the non-LM prediction block, the first final chroma prediction block, and the second final chroma prediction block (S1408). Here, the LM mode information indicates whether to use the LM mode.

The LM mode information may be one flag applied indiscriminately to two chroma components of the current chroma block or different flags for the two chroma components.

If the non-LM prediction block is optimal, the LM mode information is set not to indicate use of the LM mode. Meanwhile, if the non-LM prediction block is not optimal, the LM mode information may be set to indicate use of the LM mode.

The video encoding device encodes the LM mode information (S1410).

The video encoding device checks the LM mode information (S1412).

If the LM mode information indicates the use of the LM mode (Yes in S1412), the video encoding device determines the mixed LM mode information based on the LM prediction block, the first final chroma prediction block, and the second final chroma prediction block (S1414). Here, the mixed LM mode information indicates whether to use the mixed LM mode.

The mixed LM mode information may be one flag applied indiscriminately to two chroma components of the current chroma block or different flags for the two chroma components.

If the LM prediction block is optimal, the mixed LM mode information is set not to indicate the use of the mixed LM mode. Meanwhile, if the LM prediction block is not optimal, the mixed LM mode information may be set to indicate the use of the mixed LM mode.

The video encoding device encodes the mixed LM mode information (S1416).

The video encoding device checks the mixed LM mode information (S1418).

If the mixed LM mode information indicates the use of the mixed LM mode (Yes in S1418), the video encoding device determines the geometric mixed LM mode information based on the first final chroma prediction block and the second final chroma prediction block (S1420). Here, the geometric mixed LM mode information indicates whether to use the geometric mixed LM mode.

The geometric mixed LM mode information may be one flag applied indiscriminately to two chroma components of the current chroma block or different flags for the two chroma components.

If the first final chroma prediction block is optimal, the geometric mixed LM mode information is set not to indicate the use of the geometric mixed LM mode. Meanwhile, if the second final chroma prediction block is optimal, the geometric mixed LM mode information may be set to indicate the use of the geometric mixed LM mode.

The video encoding device encodes the geometric mixed LM mode information (S1422).

FIG. 15 is a flowchart illustrating a mixed cross-component prediction method performed by a video decoding device according to an embodiment of the present disclosure.

The video decoding device decodes LM mode information from a bitstream (S1500). Here, the LM mode information indicates whether to use the LM mode.

The LM mode information may be a single flag applied indiscriminately to two chroma components of the current chroma block or different flags for the two chroma components.

The video decoding device checks the LM mode information (S1502).

If the LM mode information does not indicate the use of the LM mode (No in S1502), the video decoding device performs prediction according to the non-LM mode to generate a non-LM prediction block of the current chroma block (S1520). Here, the non-LM mode predicts the current chroma block using a directionality-based intra prediction mode.

Meanwhile, if the LM mode information indicates the use of the LM mode (Yes in S1502), the video decoding device decodes mixed LM mode information from the bitstream (S1504). Here, the mixed LM mode information indicates whether to use the mixed LM mode.

The mixed LM mode information may be a single flag applied indiscriminately to two chroma components of the current chroma block or different flags for the two chroma components.

The video decoding device checks the mixed LM mode information (S1506).

If the mixed LM mode information does not indicate the use of the mixed LM mode (No in S1506), the video decoding device performs cross-component prediction according to the LM mode to generate an LM prediction block of the current chroma block (S1522). Here, the LM mode predicts the current chroma block using a cross-component linear model.

First, the video decoding device sets positions of reference samples adjacent to the current chroma block and the reference block. The video decoding device derives a linear model based on the similarity between adjacent reference samples of the current chroma block and the reference block. Thereafter, the video decoding device may generate an LM prediction block by applying the linear model to pixels in the reference block corresponding to pixels in the current chroma block.

Meanwhile, if the mixed LM mode information indicates the use of the mixed LM mode (Yes in S1506), the video decoding device decodes the geometric mixed LM mode information from the bitstream (S1508). Here, the geometric mixed LM mode information indicates whether the geometric mixed LM mode is used.

The geometric mixed LM mode information may be a single flag applied indiscriminately to two chroma components of the current chroma block or different flags for the two chroma components.

The video decoding device checks the geometric mixed LM mode information (S1510).

If the geometric mixed LM mode information does not indicate the use of the geometric mixed LM mode (No in S1510), the video decoding device generates a final prediction block according to the prediction between the mixed components (1524).

The video decoding device generates an LM prediction block and a non-LM prediction block of the current chroma block. As an example, the video decoding device may set weights in a base block unit based on the prediction modes of blocks located above and to the left of the current chroma block. The video decoding device may combine LM prediction blocks and non-LM prediction blocks based on weights for each block.

Meanwhile, if the geometric mixed LM mode information indicates the use of the geometric mixing LM mode (Yes in S1510), the video decoding device generates a final prediction block according to the geometric mixed cross-component prediction (1512).

The video decoding device generates an LM prediction block and a non-LM prediction block of the current chroma block. In addition, the video decoding device decodes the index indicating the form of geometric block partitioning of the current chroma bloc, and decodes the prediction mode information for each block partition of the current chroma block. Here, the prediction mode information for each block partition indicates the prediction mode of the first block partition and the second block partition of the current chroma block according to the index. For example, the video decoding device may set weights having different values for each pixel position of the LM prediction block and the non-LM prediction block based on the form of geometric block partitioning and the prediction mode information for each block partition. The video decoding device may combine the LM prediction block and the non-LM prediction block based on the set weights for each pixel position.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
155: entropy encoder
510: entropy decoder
542: intra predictor
910: reference sample composer
920: linear model deriver
930: cross-component predictor
1110: directionality-based intra predictor
1120: prediction block mixer
1310: geometric partitioning determiner

### CROSS-REFERENCE TO RELATED APPLICATIONS

This application claims priority to and the benefit of Korean Patent Application No. 10-2022-0059415 filed on May 16, 2022, and Korean Patent Application No. 10-2023-0051389, filed on Apr. 19, 2023, the entire contents of each of which are incorporated herein by reference.

1. A method of mixed cross-component prediction, performed by a video decoding device, the method comprising:
generating a linear model (LM) prediction block of a current chroma block by performing cross-component prediction according to an LM mode, wherein the LM mode uses a cross-component linear model;
generating a non-LM prediction block of the current chroma block by performing prediction according to a non-LM mode, wherein the non-LM mode uses a directionality-based intra prediction mode; and
generating a final chroma prediction block of the current chroma block by combining the LM prediction block and the non-LM prediction block based on weights.

2. The method of claim 1, further comprising:
decoding mixed LM mode information from a bitstream, wherein the mixed LM mode information indicates whether to use a mixed LM mode; and
checking the mixed LM mode information.

3. The method of claim 2, wherein, when the mixed LM mode information indicates the use of the mixed LM mode, the method of mixed cross-component prediction is performed.

4. The method of claim 2, further comprising:
decoding LM mode information from the bitstream, wherein the LM mode information indicates whether to use the LM mode; and
checking the LM mode information,
wherein, when the above LM mode information indicates the use of the LM mode, the method further comprises decoding the mixed LM mode information.

5. The method of claim 2, wherein, when the mixed LM mode information does not indicate the use of the mixed LM mode, the method only comprises generating the LM prediction block of the current chroma block.

6. The method of claim 2, wherein the mixed LM mode information is either a single flag applied indiscriminately to two chroma components of the current chroma block or different flags for the two chroma components.

7. The method of claim 1, wherein generating the LM prediction block includes:
setting positions of reference samples adjacent to the current chroma block and a reference block;
deriving a linear model based on a similarity between adjacent reference samples of the current chroma block and the reference block; and
generating the LM prediction block by applying the linear model to pixels in the reference block corresponding to pixels in the current chroma block.

8. The method of claim 1, wherein generating the final chroma prediction block includes setting the weights in block units based on a prediction mode of blocks located on top and to left of the current chroma block.

9. The method of claim 2, wherein, when the mixed LM mode information indicates the use of the mixed LM mode, further comprising:
decoding geometric mixed LM mode information from the bitstream, wherein the geometric mixed LM mode information indicates whether to use a geometric mixed LM mode; and
checking the geometric mixed LM mode information,
wherein, when the geometric mixture LM mode information does not indicate the use of the geometric mixture LM mode, the method of mixed cross-component prediction is performed.

10. The method of claim 9, wherein, when the geometric mixed LM mode information indicates the use of the geometric mixed LM mode, the method of mixed cross-component prediction is performed,
wherein the method further comprises:
decoding an index indicating a form of geometric block partitioning of the current chroma block; and
decoding prediction mode information for each block partition of the current chroma block,
wherein the prediction mode information for each block partition indicates a prediction mode of first block partition and second block partition of the current chroma block based on the index.

11. The method of claim 10, wherein generating the final chroma prediction block includes setting weights having different values for each pixel position of the LM prediction block and the non-LM prediction block based on the form of the geometric block partitioning and the prediction mode information for each block partition.

12. A method of mixed cross-component prediction of a current chroma block, performed by a video encoding device, the method comprising:
generating a linear model (LM) prediction block of the current chroma block by performing cross-component prediction according to an LM mode, wherein the LM mode uses a cross-component linear model;
generating a non-LM prediction block of the current chroma block by performing prediction according to a non-LM mode, wherein the non-LM mode uses a directionality-based intra prediction mode;
generating a first final chroma prediction block of the current chroma block by combining the LM prediction block and the non-LM prediction block based on weights for each block; and
generating a second final chroma prediction block of the current chroma block by combining the LM prediction block and the non-LM prediction block based on weights for each pixel position.

13. The method of claim 12, further comprising:
determining LM mode information based on the LM prediction block, the non-LM prediction block, the first final chroma prediction block, and the second final chroma prediction block, wherein the LM mode information indicates whether to use an LM mode; and
encoding the LM mode information.

14. The method of claim 13, further comprising:
checking the LM mode information,
wherein, when the LM mode information indicates a use of the LM mode, the method further comprising:
determining mixed LM mode information based on the LM prediction block, the first final chroma prediction block, and the second final chroma prediction block, wherein the mixed LM mode information indicates whether to use a mixed LM mode; and
encoding the mixed LM mode information.

15. The method of claim 14, further comprising:
checking the mixed LM mode information,
wherein, when the mixed LM mode information indicates the use of the mixed LM mode, the method further comprising:
determining geometric mixed LM mode information based on the first final chroma prediction block and the second final chroma prediction block, wherein the geometric mixed LM mode information indicates whether to use a geometric mixed LM mode; and
encoding the geometric mixed LM mode information.

16. A computer-readable recording medium storing a bitstream generated by a video encoding method, the video encoding method comprising:
generating a linear model (LM) prediction block of the current chroma block by performing cross-component prediction according to an LM mode, wherein the LM mode uses a cross-component linear model;
generating a non-LM prediction block of the current chroma block by performing prediction according to a non-LM mode, wherein the non-LM mode uses a directionality-based intra prediction mode;
generating a first final chroma prediction block of the current chroma block by combining the LM prediction block and the non-LM prediction block based on weights for each block; and
generating a second final chroma prediction block of the current chroma block by combining the LM prediction block and the non-LM prediction block based on weights for each pixel position.
